(19) United States
(12) Patent Application Publication
(10) Pub. No.: US 2026/0158437 A1
(43) Pub. Date: Jun. 11, 2026

(54) ADDITIVE MANUFACTURING OF SOLID-STATE ZIRCONATE MEMBRANE

(71) Applicant: Valero Services, Inc., San Antonio, TX (US)

(72) Inventors: Michael A. Miller, Helotes, TX (US); Jason Daniel Herrera, San Antonio, TX (US); Carl F. Popelar, San Antonio, TX (US); Matthew A. Poerner, San Antonio, TX (US)

(73) Assignee: Valero Services, Inc., San Antonio, TX (US)

(21) Appl. No.: 19/384,767

(22) Filed: Nov. 10, 2025

Related U.S. Application Data
(60) Provisional application No. 63/730,247, filed on Dec. 10, 2024.

(51) Int. Cl. B01D 53/22; B01D 67/00; B01D 71/02; B28B 1/00; B33Y 10/00; B33Y 70/00; B33Y 80/00

(52) U.S. Cl. CPC B01D 53/228; B01D 67/00415; B01D 71/024; B28B 1/001; B33Y 10/00; B33Y 70/00; B33Y 80/00; B01D 2257/504; B01D 2258/01; B01D 2258/02; B01D 2323/10; B01D 2323/12; B01D 2323/2181

(57) ABSTRACT

The present disclosure provides methods for manufacturing monolithic membrane structures using additive manufacturing of lithium zirconate-based materials. The methods enable creation of complex internal geometries optimized for carbon dioxide (CO₂) separation and capture from gas mixtures. Further, the disclosure provides specific material formulations combining lithium zirconate with various additives and process parameters for successful additive manufacturing. The resulting monolithic membrane structures feature alternating feed and permeant channels arranged orthogonally, with selective membrane walls enabling efficient CO₂ capture through chemisorption. The disclosed technology enables practical implementation of solid-state CO₂ capture technology for industrial and vehicle emissions.

### CROSS-REFERENCE TO RELATED APPLICATIONS

This application claims priority to U.S. Provisional Patent Application No. 63/730,247, filed Dec. 10, 2024, the content of which is incorporated herein by reference in its entirety.

### FIELD

The present disclosure relates to additive manufacturing for producing solid membrane monoliths. More particularly, the disclosure relates to methods of additive manufacturing of lithium zirconate-based membrane monoliths with internal structural features for efficient separation and capture of carbon dioxide from industrial and vehicle emissions.

### BACKGROUND

Carbon dioxide (CO₂) capture and separation from industrial and vehicle emissions remains a critical challenge in addressing climate change. Conventional CO₂ capture technologies often rely on liquid absorbents or adsorbent materials, which can be energy-intensive and may have limitations in terms of efficiency and scalability.

Lithium zirconate (LZO) has emerged as a promising material for CO₂ separation due to its high selectivity through a chemisorption mechanism. However, traditional manufacturing methods have limited the ability to create optimized structures that can maximize the surface area-to-volume ratio while maintaining mechanical integrity.

Three-dimensional (3D) additive manufacturing techniques, such as selective laser sintering (SLS) among others, have been successfully applied to various ceramic materials, including alumina (Al₂O₃), zirconia (ZrO₂), silicon carbide (SiC), and silicon nitride (Si₃N₄). However, the successful application of additive manufacturing to ionic solids like LZO has not been previously demonstrated, limiting the ability to create complex geometric structures necessary for efficient CO₂ capture.

Therefore, there exists a need for improved systems for using additive manufacturing to produce solid-state membrane monoliths.

### BRIEF SUMMARY

The present disclosure addresses this need by providing compositions and methods for manufacturing monolithic membrane structures using additive manufacturing of LZO-based materials. The resulting membrane structures feature intricate internal geometries that enable efficient separation and capture of CO₂ from gas mixtures.

Accordingly, in one aspect, the present disclosure provides a solid-state monolithic membrane for selective capture of carbon dioxide (CO₂) from feed gas, the membrane comprising: a feed channel, comprising a plurality of feed passages that are parallelly planar for the flow of feed gas; and a permeant channel, comprising a plurality of permeant passages that are parallelly planar for the flow of permeant CO₂ selectively captured from the feed gas, wherein the flow direction of the feed channel is orthogonal to that of the permeant channel, wherein the feed passages and the permeant passages are arranged in an alternating pattern separated by membrane interior walls that are capable of selectively capturing CO₂.

In some embodiments, the membrane is made from a composition comprising lithium zirconate (LZO) or a compound formulation substantially composed of LZO.

In some embodiments, the membrane is produced from three-dimensional (3D) additive manufacturing.

In some embodiments, the 3D additive manufacturing is selective laser sintering (SLS), binder jet printing, directed energy deposition (DED), and/or 3D photolithography printing.

In some embodiments, the channels further comprise plenums on the upstream and the downstream of the passages.

In some embodiments, the channels further comprise flanges on the upstream and the downstream of the plenums.

In some embodiments, the flow of permeant CO₂ is driven by a flow of sweep gas directed through the permeant channel, or by a lower pressure of the permanent passages relative to the feed gas pressure.

In some embodiments, the flow of permeant CO₂ is driven by a lower pressure of the permanent passages, which is provided by a vacuum pump and/or a passive adsorption bed.

In some embodiments, the membrane exterior walls and/or the plenum walls are impermeable to all gases.

In some embodiments, the membrane exterior walls and/or the plenum walls are made impermeable by adjusting the parameters of laser power, scan speed, and/or powder deposition rate in 3D additive manufacturing.

In some embodiments, the membrane exterior walls and/or the plenum walls are made impermeable by adhering metallic appliques thereto after the membrane is produced from additive manufacturing.

In some embodiments, the membrane exterior walls and/or the plenum walls are made impermeable by depositing a metal layer thereto using plasma magnetron sputtering.

In some embodiments, the disclosure provides a use of the membrane of any of the embodiments for selectively separating CO₂ from industrial or vehicle gas emissions.

In another aspect, the present disclosure provides a composition for additive manufacturing of solid-state zirconate membrane, the composition comprising: lithium zirconate (LZO); and one or more additives selected from the group consisting of colloidal silica, fumed silica, octamethyl-silsesquioxane (OM-POSS), tetraethoxysilane (TEOS), and dimethyldichlorosilane (DMDCS).

In some embodiments, the one or more additives comprise OM-POSS, which has a ratio of 1:6 by weight relative to LZO.

In some embodiments, the one or more additives comprise colloidal silica, which has a ratio of 3 parts by volume (mL) relative to 1 part by gram weight of LZO.

In some embodiments, the one or more additives comprise OM-POSS and TEOS, wherein TEOS has a ratio of 1.87 parts by weight relative to the combined weight of LZO and OM-POSS.

In some embodiments, the one or more additives comprise fumed silica, which has a ratio of 0.085:1 by weight relative to LZO.

In some embodiments, the one or more additives comprise fumed silica, TEOS and DMDCS, wherein TEOS has a ratio of 1 part by volume (mL) relative to 5 parts by gram weight of LZO, and DMDCS has a ratio of 2 parts by volume (mL) relative to 5 parts by gram weight of LZO.

In some embodiments, the composition is pressed into a compact form before additive manufacturing.

In yet another aspect, the present disclosure provides a method for additive manufacturing of solid-state zirconate membrane, the method comprising: providing a zirconate-based composition; and applying 3D additive manufacturing to the zirconate-based composition to produce a 3D object.

In some embodiments, the method further comprises a step of pressing the zirconate-based composition into a compact form prior to applying 3D additive manufacturing.

In some embodiments, the pressing comprises using a pressure up to about 69 MPa.

In some embodiments, the method further comprises a step of subjecting the 3D object to one or more heat treatments.

In some embodiments, the zirconate-based composition comprises the composition of the preceding embodiments.

In some embodiments, the 3D additive manufacturing is selective laser sintering (SLS), binder jet printing, directed energy deposition (DED), and/or 3D photolithography printing.

In some embodiments, the 3D additive manufacturing is selective laser sintering (SLS), which comprises using a laser power range of 78-87 W, a scan speed of 70 mm/s, and/or a hatch distance of 3 mm.

In some instances, the manufactured membrane comprises the structure of the solid-state monolithic membrane in accordance with the preceding embodiments.

In some embodiments, the method further comprises a step of using the manufactured membrane to selectively separate CO₂ from industrial or vehicle gas emissions.

Unless defined otherwise, the term “about,” particularly in reference to a given quantity, is meant to encompass deviations of plus or minus ten percent.

### BRIEF DESCRIPTION OF THE DRAWINGS

FIG. 1 shows a special additive manufacturing build plate used to assess the efficacy of laser sintering various types of ceramic substrates.

FIG. 2 shows an optical image of a laser line scan after interacting with a packed bed of lithium zirconate (LZO)/colloidal silica.

FIG. 3 shows scanning electron microscopy (SEM) images at 5,000× and 20,000× magnifications of the trench region showing sintered particle morphology.

FIG. 4 shows an optical image of a laser line scan interacting with lithium zirconate (LZO)/octamethyl-silsesquioxane (OM-POSS) material.

FIG. 5 shows scanning electron microscopy (SEM) images at 1,000× and 10,000× magnifications showing deformed POSS micro-aggregates.

FIG. 6 shows optical images of laser line scan interaction with a thin powder bed of lithium zirconate (LZO).

FIG. 7 shows a schematic of the monolithic membrane assembly including top view, three-dimensional perspective, and internal details.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown but are to be accorded the scope consistent with the claims.

The present disclosure provides methods for manufacturing monolithic membrane structures using additive manufacturing of lithium zirconate-based materials. These structures enable efficient separation and capture of CO₂ from gas mixtures through a combination of optimized geometry and selective material properties.

Three-dimensional (3D) additive manufacturing, or simply additive manufacturing, is a process where objects are created by depositing materials layer by layer according to a digital 3D model, in contrast to traditional “subtractive” manufacturing methods that cut away material from a larger block. The technology encompasses several distinct processes, each with unique capabilities and applications.

Selective Laser Sintering of ceramics or ceramic-like materials is one type of additive manufacturing process that uses a laser to selectively fuse ceramic powder particles together layer-by-layer, creating a three-dimensional object. In this technique, a laser scans and sinters the ceramic or ceramic-like powder material based on a digital model, solidifying it into the desired shape. After forming the initial sintered object or “green body,” it is removed from the additive manufacturing process tool and subjected to various heat treatments in a furnace under specific conditions to achieve the desired density and bulk properties, such as strength.

Binder jet printing represents another approach where a liquid binding agent is selectively deposited onto powder materials to bind the particles together. This method often requires post-processing steps such as sintering and can work with various materials including metals and ceramics. The process offers good scalability and can be cost-effective for certain applications.

Directed energy deposition (DED) involves material, usually metal powder or wire, being deposited and simultaneously melted using a laser, electron beam, or plasma arc as an energy source. This technique is particularly valuable for repairs and adding features to existing parts, and it excels in the production of large metal components.

Photolithography, also known as stereolithography (SLA), uses light, typically UV, to cure liquid photopolymer resin. This method offers very high precision and smooth surface finish, making it particularly suitable for prototypes and dental applications where detail is crucial.

Fused deposition modeling (FDM) represents one of the most widely accessible additive manufacturing technologies, where material, typically plastic filament, is heated and extruded in layers that fuse together. This method has become ubiquitous in desktop 3D printers and is particularly well-suited for prototypes and simple parts.

While SLS can be applied to several different kinds of ceramic materials to produce 3D objects, including alumina (Al₂O₃), zirconia (ZrO₂), silicon carbide (SiC), silicon nitride (Si₃N₄), lithium disilicate (Li₂Si₂O₅), and certain glass ceramics, its successful application to the ionic solid, lithium zirconate (Li₂ZrO₃), or composite formulation thereof, was not previously known.

Lithium zirconate (LZO) is an ionic solid with ceramic properties that have been investigated for its potential use as a solid-state membrane in various applications, including the separation of CO₂ from gas mixtures, such as in carbon capture and storage and hydrogen production. LZO has shown promise as a solid-state membrane for CO₂ separation via capture and regeneration due to its high selectivity for CO₂. This selectivity arises from a chemisorption equilibrium reaction between CO₂ and LZO, yielding lithium carbonate (Li₂CO₃) and zirconate (ZrO₂) through a complex mechanism whereby CO₂ is incorporated into the crystal lattice of LZO, whereas other gas species are much less readily absorbed via physisorption.

### Material Compositions

The disclosure provides several specific formulations for successful additive manufacturing processing of LZO-based materials. These formulations have been optimized for additive manufacturing while maintaining the desired CO₂ capture properties. The first formulation comprises commercially-obtained LZO powder (99.5%, D₅₀<5.0 μm) combined with colloidal silica (50 wt. % in water) as a binder in a ratio of 6:1 by weight (LZO: colloidal silica).

A second formulation combines LZO powder with octamethyl-silsesquioxane (OM-POSS) in a ratio of 6:1 by weight. This mixture is further enhanced by the addition of tetraethoxysilane (TEOS) at 1.87 parts by weight relative to the combined weight of LZO and OM-POSS.

Additional formulation options have been developed, including combinations with fumed silica in a 0.085:1 weight ratio relative to LZO. More complex formulations incorporating both TEOS and dimethyldichlorosilane (DMDCS) have also been demonstrated, with TEOS added at a ratio of 1 part by volume per 5 parts by weight of LZO, and DMDCS included at 2 parts by volume per 5 parts by weight of LZO.

### Membrane Structure and Design

The 3D monolithic membrane structure comprises several key components designed to optimize CO₂ separation efficiency. The feed channel configuration consists of multiple parallel planar feed passages designed for efficient flow of feed gas. These passages are integrated with inlet and outlet plenums and connected via appropriate flanges to facilitate gas flow management.

The permeant channel configuration includes multiple parallel planar permeant passages oriented orthogonally to the feed channels. This orientation optimizes CO₂collection and transport through the structure. Like the feed channels, these passages are also integrated with appropriate plenums and flanges.

The wall structures within the membrane are carefully designed to achieve optimal performance. Selective membrane interior walls separate the channels, while impervious exterior walls and plenum walls are incorporated where needed. The entire structure is engineered to provide both mechanical strength and efficient gas separation.

Gas flow management within the structure can be achieved through multiple mechanisms. Permeant CO₂ flow can be driven either by sweep gas directed through the permeant channels or by maintaining a pressure differential between feed and permeant passages. The pressure differential can be maintained using a vacuum pump, a passive adsorption bed, or a combination of both approaches.

### Manufacturing Process Details

The manufacturing process involves several key steps and carefully controlled parameters. The material preparation begins with thorough mixing of LZO with selected additives, followed by cold-pressing into initial form under pressures of up to 69 MPa. The pressed material then forms an appropriate powder bed for additive manufacturing processing.

The selective laser sintering process employs specific parameters that have been optimized for these materials. The laser power is maintained within a range of 78-87 W, with a scan speed of 70 mm/s and a hatch distance of 3 mm. The structure is built layer by layer following a detailed digital model.

Wall impermeability can be achieved through several methods. During the build process, laser parameters can be adjusted to create impervious sections where needed. Post-processing options include the application of metallic appliques or the use of plasma magnetron sputtering to deposit a metal layer. The specific method is selected based on the requirements of each section of the structure.

Post-processing steps include heat treatments to achieve optimal density and strength, the addition of any necessary fittings or connections, and comprehensive testing of gas impermeability where required. These steps ensure the final structure meets all performance requirements for CO₂ separation applications.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

### EXAMPLES

The following examples are offered to illustrate provided embodiments and are not intended to limit the scope of the present disclosure.

### Example 1: Demonstration of LZO Sintering

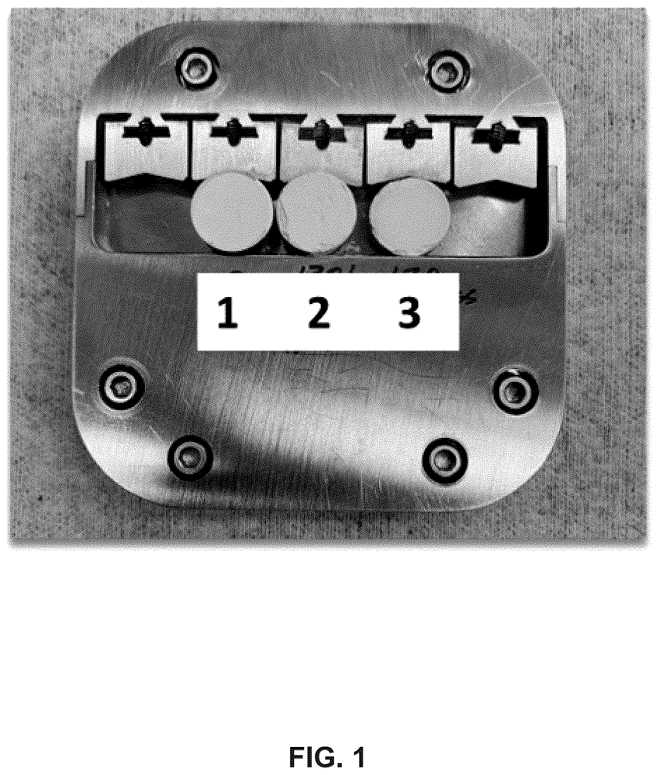

A comprehensive study was conducted to demonstrate the feasibility of laser sintering various LZO-based formulations. As shown in FIG. 1, three distinct test substrates were prepared on a specially designed stainless-steel additive manufacturing build plate that accommodated multiple test pellets. The three positions on the build plate contained different substrate formulations to evaluate processing characteristics and resulting material properties.

The first test substrate (position 1 in FIG. 1) consisted of LZO powder (99.5%, D50<5.0 μm) mixed with colloidal silica (50 wt. % in water) in a 6:1 weight ratio. This mixture was cold-pressed in a 9.4 mm die at 69 MPa and mechanically affixed to the build plate. The second test substrate (position 2 in FIG. 1) utilized LZO powder combined with OM-POSS in a 6:1 weight ratio, which was mixed for 15 minutes before the addition of 1.87 parts TEOS by weight. The third test substrate (position 3 in FIG. 1) was configured as a powder bed, using a base substrate identical to the second test substrate but with additional pure LZO powder manually spread on the surface to create a thin powder bed mimicking typical additive manufacturing layer conditions.

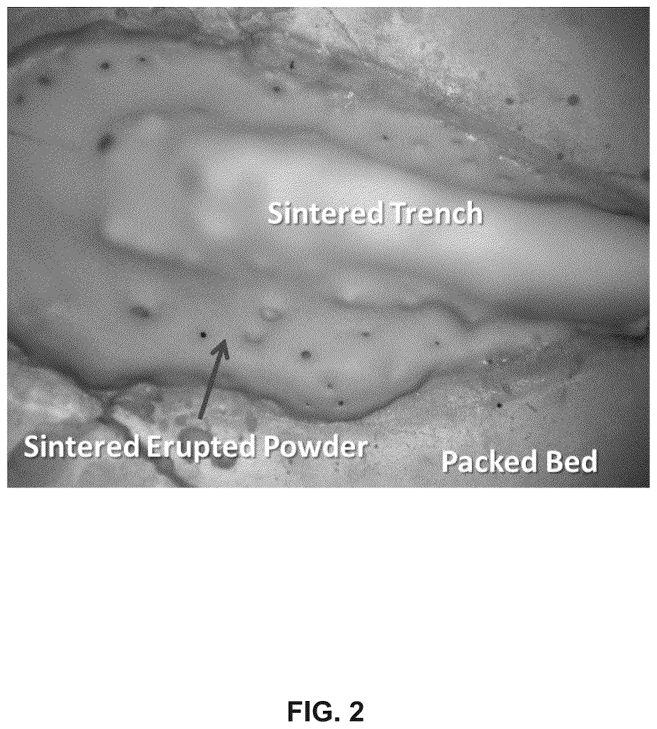

Laser sintering was performed using a Renishaw AM-250 tool, with four discrete line scans performed on each substrate at different laser power levels between 78 and 87 W, while maintaining a constant scan speed of 70 mm/s and hatch distance of 3 mm. The results of these line scans are documented in FIGS. 2-6.

### Example 2: Morphological Analysis

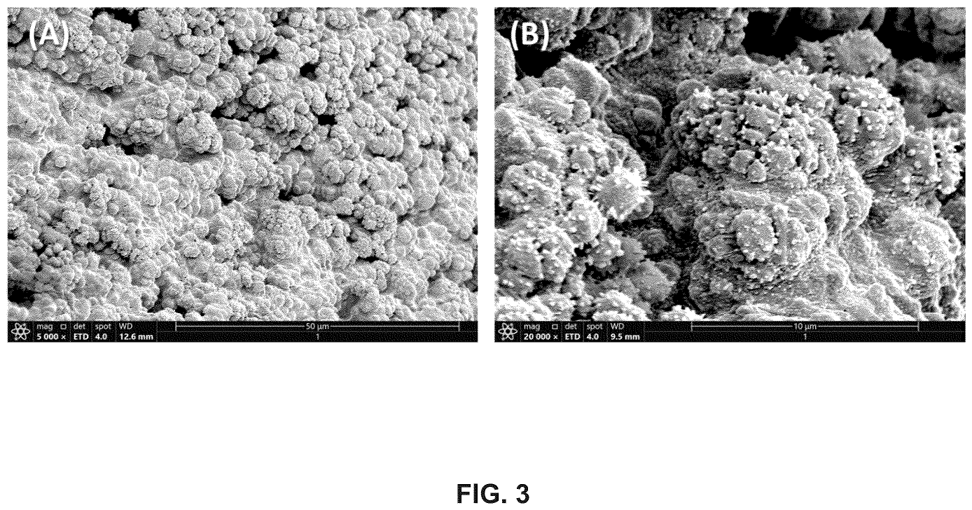

The LZO/colloidal silica formulation showed clear evidence of sintering in the laser scan trenches, as illustrated in FIG. 2, where the optical image reveals distinct sintered material in and near the trench of the line scan. Further analysis using scanning electron microscopy, shown in FIG. 3 at 5,000× (A) and 20,000× (B) magnifications, revealed fused particle clusters and morphology characteristics of sintered particles in the trench region.

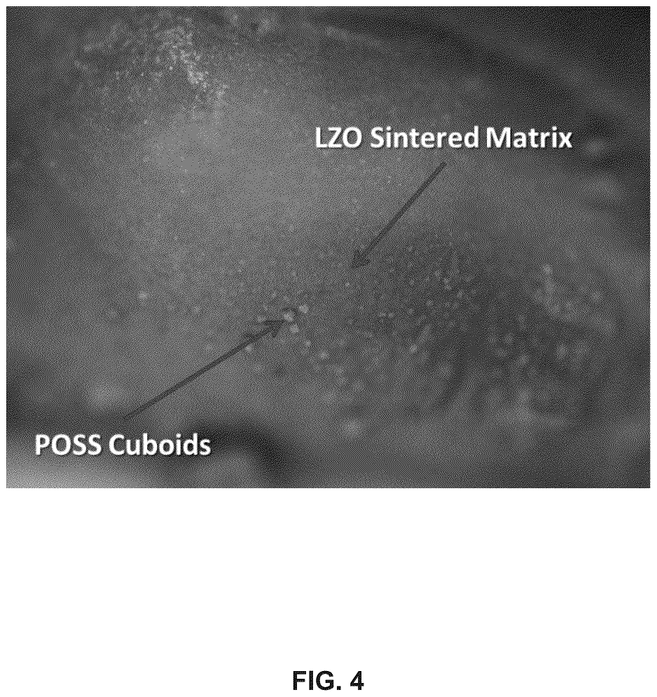

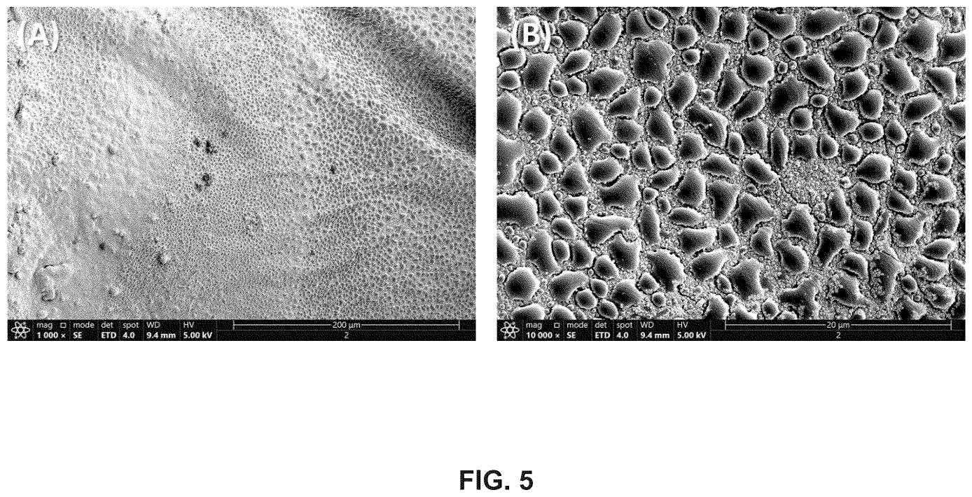

Analysis of the LZO/OM-POSS formulation, depicted in FIG. 4, demonstrated the presence of POSS cuboids surrounded by a sintered matrix of LZO. The SEM images in FIG. 5, taken at 1,000× (A) and 10,000× (B) magnifications, reveal deformed POSS micro-aggregates surrounded by a conformal sintered matrix of LZO, indicating successful integration of the components.

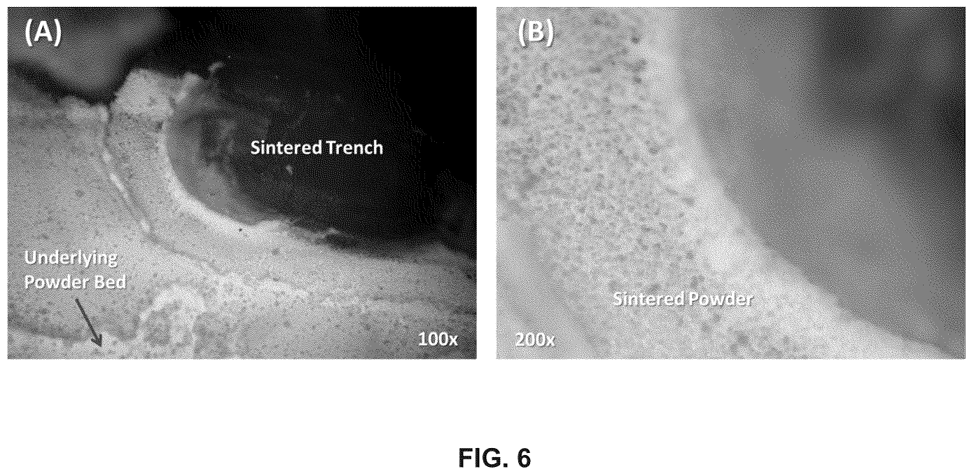

The powder bed configuration results are shown in FIG. 6, where optical images acquired at 100× (A) and 200× (B) magnifications demonstrate sintered powder near and in the trench of the line scan. These images confirm successful sintering of the powder bed, similar to the results obtained with the pressed pellets, validating the feasibility of layer-by-layer construction for full-scale production.

### Example 3: Complete Monolithic Structure

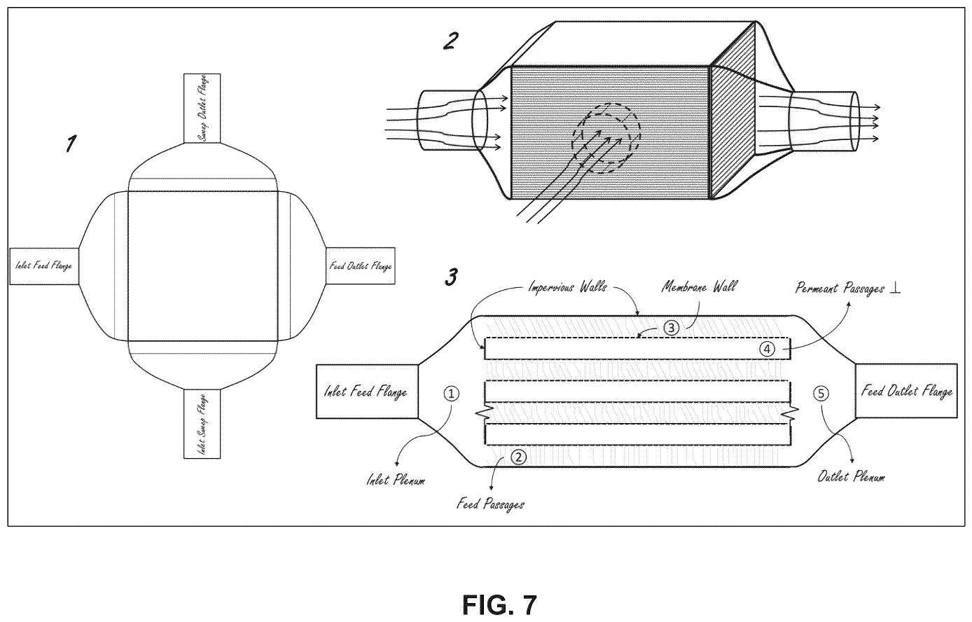

Based on the successful sintering demonstrations, a full monolithic membrane structure was manufactured incorporating all key design elements required for efficient CO₂ separation. As illustrated in FIG. 7, the structure features three key components: (1) a top view showing the configurations of inlet and outlet plenums and flanges, (2) a three-dimensional perspective of the stacked structure, and (3) the internal details of the gas passages, membrane walls, and impervious walls in an alternating arrangement for feed and permeant gases.

The completed structure demonstrated successful integration of orthogonal feed and permeant channels with appropriate plenums and flanges, as shown in views 1 and 2 of FIG. 7. The detailed cross-sectional view in part 3 of FIG. 7 reveals the successful implementation of both selective membrane walls and impervious walls, creating a fully functional separation device. This configuration maintained appropriate separation between feed and permeant gases while allowing selective CO₂ capture through the membrane walls, validating the manufacturing approach for practical applications.

The structure's design, as detailed in FIG. 7, enables efficient gas flow management through the orthogonal arrangement of feed and permeant passages. The impervious walls, shown in section 3 of FIG. 7, effectively prevent undesired gas mixing, while the selective membrane walls enable the desired CO₂ separation functionality. Testing confirmed that the LZO's selective CO₂ capture properties were preserved within the printed structure, demonstrating the success of the manufacturing method for creating functional CO₂ separation devices.

Taken together, these examples demonstrate successful implementation of using the disclosed compositions and methods for additive manufacturing of LZO-based monolithic membranes for CO₂ capture. The examples validate key aspects of the disclosure, from the initial demonstration of successful laser sintering of various LZO-based formulations, through detailed morphological confirmation of proper material fusion and structural formation, to the ultimate creation of a complete monolithic membrane structure with integrated feed and permeant channels. The microscopy results confirm successful sintering across multiple material formulations, while the final membrane structure demonstrates the practical implementation of the manufacturing process to create functional CO₂ separation devices with complex internal geometries. These results establish the feasibility of using additive manufacturing to create advanced ceramic membrane structures for gas separation applications.

What is claimed is:

1. A solid-state monolithic membrane for selective capture of carbon dioxide (CO₂) from feed gas, the membrane comprising:
a feed channel, comprising a plurality of feed passages that are parallelly planar for the flow of feed gas; and
a permeant channel, comprising a plurality of permeant passages that are parallelly planar for the flow of permeant CO₂ selectively captured from the feed gas,
wherein the flow direction of the feed channel is orthogonal to that of the permeant channel,
wherein the feed passages and the permeant passages are arranged in an alternating pattern separated by membrane interior walls that are capable of selectively capturing CO₂.

2. The membrane of claim 1, wherein the membrane is made from a composition comprising lithium zirconate (LZO) or a compound formulation substantially composed of LZO.

3. The membrane of claim 1, wherein the membrane is produced from three-dimensional (3D) additive manufacturing.

4. The membrane of claim 3, wherein the three-dimensional (3D) additive manufacturing is selective laser sintering (SLS), binder jet printing, directed energy deposition (DED), and/or 3D photolithography printing.

5. The membrane of claim 1, wherein the channels further comprise plenums on the upstream and the downstream of the passages.

6. The membrane of claim 5, wherein the channels further comprise flanges on the upstream and the downstream of the plenums.

7. The membrane of claim 1, wherein the flow of permeant CO₂ is driven by a flow of sweep gas directed through the permeant channel, or by a lower pressure of the permanent passages relative to the feed gas pressure.

8. The membrane of claim 7, wherein the flow of permeant CO₂ is driven by a lower pressure of the permanent passages, which is provided by a vacuum pump and/or a passive adsorption bed.

9. The membrane of claim 1, wherein the membrane exterior walls and/or the plenum walls are impermeable to all gases.

10. The membrane of claim 9, wherein the membrane exterior walls and/or the plenum walls are made impermeable by adjusting the parameters of laser power, scan speed, and/or powder deposition rate in three-dimensional (3D) additive manufacturing.

11. The membrane of claim 9, wherein the membrane exterior walls and/or the plenum walls are made impermeable by adhering metallic appliques thereto after the membrane is produced from additive manufacturing.

12. The membrane of claim 9, wherein the membrane exterior walls and/or the plenum walls are made impermeable by depositing a metal layer thereto using plasma magnetron sputtering.

13. A use of the membrane of claim 1 for selectively separating CO₂ from industrial or vehicle gas emissions.

14. A composition for additive manufacturing of solid-state zirconate membrane, the composition comprising:
lithium zirconate (LZO); and
one or more additives selected from the group consisting of colloidal silica, fumed silica, octamethyl-silsesquioxane (OM-POSS), tetraethoxysilane (TEOS), and dimethyldichlorosilane (DMDCS).

15. The composition of claim 14, wherein the one or more additives comprise OM-POSS, which has a ratio of 1:6 by weight relative to LZO.

16. The composition of claim 14, wherein the one or more additives comprise colloidal silica, which has a ratio of 3 parts by volume (mL) relative to 1 part by gram weight of LZO.

17. The composition of claim 14, wherein the one or more additives comprise OM-POSS and TEOS, and wherein TEOS has a ratio of 1.87 parts by weight relative to the combined weight of LZO and OM-POSS.

18. The composition of claim 14, wherein the one or more additives comprise fumed silica, which has a ratio of 0.085:1 by weight relative to LZO.

19. The composition of claim 14, wherein the one or more additives comprise fumed silica, TEOS and DMDCS, and wherein TEOS has a ratio of 1 part by volume (mL) relative to 5 parts by gram weight of LZO, and DMDCS has a ratio of 2 parts by volume (mL) relative to 5 parts by gram weight of LZO.

20. The composition of claim 14, wherein the composition is pressed into a compact form before additive manufacturing.

21. A method for additive manufacturing of solid-state zirconate membrane, the method comprising:
providing a zirconate-based composition; and
applying three-dimensional (3D) additive manufacturing to the zirconate-based composition to produce a 3D object.

22. The method of claim 21, further comprising a step of pressing the zirconate-based composition into a compact form prior to applying 3D additive manufacturing.

23. The method of claim 22, wherein the pressing comprises using a pressure up to about 69 MPa.

24. The method of claim 21, further comprising a step of subjecting the 3D object to one or more heat treatments.

25. The method of claim 21, wherein the zirconate-based composition comprises:
lithium zirconate (LZO); and
one or more additives selected from the group consisting of colloidal silica, fumed silica, octamethyl-silsesquioxane (OM-POSS), tetraethoxysilane (TEOS), and dimethyldichlorosilane (DMDCS).

26. The method of claim 21, wherein the 3D additive manufacturing is selective laser sintering (SLS), binder jet printing, directed energy deposition (DED), and/or 3D photolithography printing.

27. The method of claim 21, wherein the 3D additive manufacturing is selective laser sintering (SLS), which comprises using a laser power range of 78-87 W, a scan speed of 70 mm/s, and/or a hatch distance of 3 mm.

28. The method of claim 21, wherein the 3D object comprises:
a feed channel, comprising a plurality of feed passages that are parallelly planar for the flow of feed gas; and
a permeant channel, comprising a plurality of permeant passages that are parallelly planar for the flow of permeant CO₂ selectively captured from the feed gas,
wherein the flow direction of the feed channel is orthogonal to that of the permeant channel,
wherein the feed passages and the permeant passages are arranged in an alternating pattern separated by membrane interior walls that are capable of selectively capturing CO₂.

29. The method of claim 21, further comprising a step of using the manufactured membrane to selectively separate CO₂ from industrial or vehicle gas emissions.
